(19) United States
(12) Patent Application Publication
(10) Pub. No.: US 2022/0127900 A1
(43) Pub. Date: Apr. 28, 2022

(54) SPACER FRAME JOINER CLIP AND METHOD OF USE

(71) Applicant: GED Integrated Solution, Inc, Glenwillow, OH (US)

(72) Inventors: William A. Briese, Hinckley, OH (US); John Grismer, Cuyahoga Falls, OH (US)

(21) Appl. No.: 17/512,985

(22) Filed: Oct. 28, 2021

Related U.S. Application Data
(60) Provisional application No. 63/106,504, filed on Oct. 28, 2020.

(51) Int. Cl. E06B 3/667; E06B 3/663; E06B 3/673; F16B 2/20

(52) U.S. Cl. CPC E06B 3/667; E06B 3/66309; E06B 2003/66395; F16B 2/20; E06B 3/67313

(57) ABSTRACT

A joiner clip for use in a spacer frame assembly and method of assembly are disclosed herein. The joiner clip includes first and second arms coupled to and extending away from a body, the first and second arms comprising mirror images of each other across a first mirror image axis. The first and second arms are housed within a first channel end of a linear spacer frame when assembled. The joiner clip further includes third and fourth arms coupled to and extending away from the body and away from the first and second arms, the third and fourth arms comprising mirror images of each other across the first mirror image axis. The third and fourth arms are housed within an opposite frame end of the linear spacer frame when assembled. When assembled, the body spaces the first channel end from the opposite frame end.

### CROSS REFERENCES TO RELATED APPLICATIONS

The present application claims priority under 35 U.S.C. § 119(e) to currently pending U.S. Provisional Patent Application Ser. No. 63/106,504 filed Oct. 28, 2020 entitled SPACER FRAME JOINER CLIP AND METHOD OF USE. The above-identified application is incorporated herein by reference in its entirety for all purposes.

### FIELD OF DISCLOSURE

The present disclosure relates to a joiner clip for a spacer frame and method of making same, and more specifically, a joiner clip for use in traditional and thermally efficient spacer frames for use with insulating glass units.

### BACKGROUND

Insulating glass units (“IGUs”) are used in windows to reduce heat loss from building interiors during cold weather. IGUs are typically formed by a spacer assembly sandwiched between glass lites. A spacer assembly usually comprises a frame structure extending peripherally about the unit, a sealant material adhered both to the glass lites and the frame structure, and a desiccant for absorbing atmospheric moisture within the unit. The margins of the glass lites are flush with or extend slightly outwardly from the spacer assembly. The sealant extends continuously about the frame structure periphery and its opposite sides so that the space within the IGUs is hermetic.

There have been numerous proposals for constructing IGUs. One type of IGU was constructed from an elongated corrugated sheet metal strip-like frame embedded in a body of hot melt or sealant material. Desiccant was also embedded in the sealant. The resulting composite spacer was packaged for transport and storage by coiling it into drum-like containers. When fabricating an IGU, the composite spacer was partially uncoiled and cut to length. The spacer was then bent into a rectangular shape and sandwiched between conforming glass lites.

Another IGU construction has employed tubular, roll formed aluminum or steel frame elements connected at their ends to form a square or rectangular spacer frame. The frame sides and corners were covered with sealant (e.g., butyl material, hot melt, reactive hot melt, or modified polyurethane) for securing the frame to the glass lites. The sealant provided a barrier between atmospheric air and the IGU interior, which blocked entry of atmospheric water vapor. Particulate desiccant deposited inside the tubular frame elements communicated with air trapped in the IGU interior to remove the entrapped airborne water vapor and thus preclude its condensation within the unit. Thus, after the water vapor entrapped in the IGU was removed internal condensation only occurred when the unit failed.

In some cases, the sheet metal was roll formed into a continuous tube, with desiccant inserted, and fed to cutting stations where “V” shaped notches were cut in the tube at corner locations. The tube was then cut to length and bent into an appropriate frame shape. The continuous spacer frame, with an appropriate sealant in place, was then assembled in an IGU.

Alternatively, individual roll formed spacer frame tubes were cut to length and “corner keys” were inserted between adjacent frame element ends to form the corners. In some constructions, the corner keys were foldable so that the sealant could be extruded onto the frame sides as the frame moved linearly past a sealant extrusion station. The frame was then folded to a rectangular configuration with the sealant in place on the opposite sides. The spacer assembly thus formed was placed between glass lites and the IGU assembly completed.

IGUs have failed because atmospheric water vapor infiltrated the sealant barrier. Infiltration tended to occur at the frame corners because the opposite frame sides were at least partly discontinuous there. For example, frames where the corners were formed by cutting “V” shaped notches at corner locations in a single long tube. The notches enabled bending the tube to form mitered corner joints; but afterwards potential infiltration paths extended along the corner parting lines substantially across the opposite frame faces at each corner.

Likewise in IGUs employing traditional corner keys, potential infiltration paths were formed by the junctures of the keys and frame elements. Furthermore, when such frames were folded into their final forms with sealant applied, the amount of sealant at the frame corners tended to be less than the amount deposited along the frame sides. Reduced sealant at the frame corners tended to cause vapor leakage paths.

In all these proposals the frame elements had to be cut to length in one way or another and, in the case of frames connected together by corner keys, the keys were installed before applying the sealant. These were all manual operations, which limited production rates. Accordingly, fabricating IGUs from these frames entailed generating appreciable amounts of scrap and performing inefficient manual operations.

In spacer frame constructions where the roll forming occurred immediately before the spacer assembly was completed, sawing, desiccant filling and frame element end plugging operations had to be performed by hand which greatly slowed production of units.

U.S. Pat. No. 5,361,476 to Leopold discloses a method and apparatus for making IGUs wherein a thin flat strip of sheet material is continuously formed into a channel shaped spacer frame having corner structures and end structures, the spacer thus formed is cut off, sealant and desiccant are applied and the assemblage is bent to form a spacer assembly. U.S. Pat. No. 5,361,476 is incorporated herein by reference in its entirety.

U.S. Patent. Pub. No. 2019/0071919 to McGlinchy et al. further describes discloses spacer frames for use in separate first and second glass lites of a window, wherein the spacer frame includes a thermal interruption strip, and describes a method of fabrication of the spacer frame including the thermal interruption strip. U.S. Patent. Pub. No. 2019/0071919 is incorporated herein by reference in their entireties.

U.S. Pat. No. 7,448,246 to Briese et al. further describes the process of corner fabrication of a spacer frame. U.S. Pat. No. 8,720,026 to McGlinchy discusses additional methods of producing spacer frames. U.S. Pat. No. 9,428,953 to Briese et al. discusses methods of producing spacer frames as well as spacer frame assembly structures. U.S. Pat. Nos. 7,448,246, 8,720,026, and 9,428,953 are incorporated herein by reference in their entireties.

### SUMMARY

One aspect of the disclosure comprises a clip for coupling two ends of a spacer frame. The joiner clip includes a body extending along a lateral axis and a longitudinal axis, a first arm coupled to and extending from the body in a first direction parallel to said lateral axis away from the longitudinal axis, and a second arm coupled to and extending from the body in a second direction opposite the first direction and parallel to the lateral axis away from the longitudinal axis.

Another aspect of the present disclosure comprises a method of assembly for a spacer frame assembly comprising the steps of providing a spacer frame having a substantially linear channel comprising two lateral walls connected by a peripheral wall, the spacer frame, when assembled, including at least three sides and corresponding corners between each of said sides, the spacer frame defining a primary channel between a first corner and a leading end of the spacer frame and an opposite channel between a second corner and a trailing end of the spacer frame. The method further comprises providing a joiner clip comprising a body coupled to first and second arms at first ends of the first and second arms, the first and second arms extending away from the body along a lateral axis, the first arm extending in a first direction, and the second arm extending in a second direction, the first direction opposite the second direction, the first and second arms each defining a peripheral face, a lateral face and a flange face, the lateral face linking the peripheral face to the flange face, the first and second arms defining first and second connecting faces coupled to and spaced from each other by a directing face at second ends of the first and second arms, the first ends opposite the second ends, the first connecting face extending transversely from the flange face and the lateral face, the second connecting face extending transversely from the lateral face and the peripheral face, the directing face extending transversely from the lateral face, the first and second connecting faces and the directing face converging at a leading face. The method additionally comprises inserting the first arm into the primary channel until the leading end is in contact with the body, the leading end interacting with at least one of the first connecting face, the second connecting face, or the directing face of the first arm during insertion. Moreover, the method comprises inserting the second arm into the opposite channel until the trailing end is in contact with the body, the trailing end interacting with at least one of the first connecting face, the second connecting face, or the directing face of the second arm during insertion, wherein responsive to the leading and trailing ends being in contact with the body, the spacer frame is in an assembled position.

Yet another aspect of the present disclosure includes spacer frame assembly, comprising a spacer frame comprising a substantially linear channel. The channel including first and second lateral walls connected by a peripheral wall, at least three sides and corresponding corners between each of the sides when the spacer frame is in an assembled position, a first leg extending between a first corner and a leading edge of the channel and a second leg extending between a second corner and a trailing edge of the channel, and first and second stiffening flanges supported by the first and second lateral walls, respectively, the first and second stiffening flanges defining first and second internal faces, the internal faces opposite the peripheral wall of the channel, the spacer frame having a spacer height extending from the stiffening flanges to the peripheral wall, and a spacer width extending between the first and second lateral walls. The spacer frame assembly further includes a joiner clip for coupling the leading end of the spacer frame to the trailing end of the spacer frame in the assembled position. The joiner clip includes a body comprising a u-shaped channel having first and second channel lateral walls coupled together by a channel peripheral wall, the body having a body height and a body width, the body height substantially equal to the spacer height, and the body width substantially equal to the spacer width, the body extending along a lateral axis and longitudinal axis. The joiner clip further includes a first arm and a third arm coupled to the body at first ends of the first and third arms, the first and third arms extending away from the body in a first direction parallel to the lateral axis away from the longitudinal axis, a second arm and a fourth arm coupled to the body at first ends of the second and fourth arms, the second and fourth arms extending away from the body in a second direction opposite the first direction and parallel to the lateral axis away from the longitudinal axis, wherein the first and second arms each define a peripheral face, a lateral face and a flange face, the lateral face linking the peripheral face to the flange face, the flange face supporting flange wedges, the first and second arms defining first and second connecting faces coupled to and spaced from each other by a directing face at second ends of the first and second arms, the first ends opposite the second ends, the first connecting face extending transversely from the flange face and the lateral face, the second connecting face extending transversely from the lateral face and the peripheral face, the directing face extending transversely from the lateral face, the first and second connecting faces and the directing face converging at a leading face, the first arm and second arms having an arm height extending between the flange face to the lateral face, the first arm comprising a mirror image of the third arm across the lateral axis, and the second arm comprising a mirror image of the fourth arm across the lateral axis, the first arm spaced from the third arm an arm width, the arm height less than the body height and the arm width less than the body width. The joiner also includes a gas aperture extending through the channel peripheral wall. Responsive to the spacer frame being coupled to the joiner clip in an assembled position, the leading edge and the trailing edge are in contact with the body, the first and third arms are housed within the first leg, and the second and fourth arms are housed within the second leg, the lateral faces of the first and third arms are in contact with the lateral walls of the first leg, and the lateral faces of the second and fourth arms are in contact with the lateral walls of the second leg, and the flange faces of the first and third arms are in contract with the first and second internal faces of the stiffening flange on the first leg, and the flange faces of the second and fourth arms are in contact with the first and second internal faces of the stiffening flanges on the second leg. Further in the assembled position the peripheral faces of the first and third arms are in contact with the peripheral wall of the first leg, and the peripheral faces of the second and fourth arms are in contact with the peripheral wall of the second leg, the flange wedge is housed within a clip notch defined in the stiffening flanges of the first and second legs, and the first and second connecting faces and the directing face of the arms are spaced from the stiffening flanges, the first and second lateral walls, and the peripheral wall of the first and second legs.

### BRIEF DESCRIPTION OF THE SEVERAL VIEWS OF THE DRAWINGS

The foregoing and other features and advantages of the present disclosure will become apparent to one skilled in the art to which the present disclosure relates upon consideration of the following description of the disclosure with reference to the accompanying drawings, wherein like reference numerals, unless otherwise described refer to like parts throughout the drawings and in which:

FIG. 1A is an elevation construction view of a spacer frame constructed in accordance with one example embodiment of the present disclosure;

FIG. 1B is an elevation assembled view of the spacer frame of FIG. 1A;

FIG. 1C is a perspective assembled view of the spacer frame of FIG. 1A;

FIG. 1D is a magnified view of the assembled view of a portion of the spacer frame of FIG. 1C;

FIG. 1E is a perspective assembled view of the spacer frame of FIG. 1A, illustrating a required application of sealant;

FIG. 2 is a perspective view of an insulating glass unit including glass lites;

FIG. 2A is a schematic block diagram of a production line for manufacturing a spacer frame in accordance with one example embodiment of the present disclosure;

FIG. 3 is a cross sectional view seen approximately from the plane indicated by the line 3-3 of FIG. 2;

FIG. 4A is a plan view of flat stock after a punching operation that will be formed into one or more spacer frame assemblies before the flat stock is roll formed or has sealant applied;

FIG. 4B is a plan view of the spacer frame assembly of FIG. 4A after a roll forming operation in an unfolded condition;

FIG. 4C is side elevation view of the spacer frame assembly of FIG. 4B;

FIG. 4D is an enlarged elevation view seen approximately from the plane indicated by the line 4D-4D of FIG. 4C;

FIG. 5A is a plan view of flat stock having a thermal interruption strip after a punching operation that will be formed into one or more spacer frame assemblies before the flat stock is roll formed or has sealant applied;

FIG. 5B is a plan view of the spacer frame assembly of FIG. 5A after a roll forming operation in an unfolded condition;

FIG. 5C is side elevation view of the spacer frame assembly of FIG. 5B;

FIG. 5D is an enlarged elevation view seen approximately from the plane indicated by the line 5D-5D of FIG. 5C;

FIG. 6 is a fragmentary elevation view of a spacer frame forming part of the unit of FIG. 2 which is illustrated in a partially constructed condition;

FIG. 7 is a bottom perspective view of a spacer frame assembly joiner clip in accordance with one example embodiment of the present disclosure;

FIG. 8 is a left side elevation view of FIG. 7;

FIG. 9 is a front and rear elevation view of FIG. 7;

FIG. 10 is a bottom plan view of FIG. 7;

FIG. 10A is a magnified view of circle 10A of FIG. 10;

FIG. 11 is a top plan view of FIG. 7;

FIG. 11A is a magnified view of circle 11A of FIG. 11;

FIG. 12 is a perspective view of a spacer frame in the process of being assembled with a joiner clip in in accordance with one example embodiment of the present disclosure;

FIG. 13 is a perspective view of a section of a spacer frame assembly and joiner clip in a pre-assembled position in accordance with one example embodiment of the present disclosure;

FIG. 14 is a perspective view of a section of a spacer frame assembly and joiner clip in an assembled position in accordance with one example embodiment of the present disclosure;

FIG. 15 is a schematic cross-section view taken along the line 15-15 of FIG. 14;

FIG. 15A is a plan view as viewed from the line 15a-15a of FIG. 15;

FIG. 16 is a schematic cross-section view taken along the line 16-16 of FIG. 14, wherein a single projection is present;

FIG. 17 is a perspective view of an insulating glass unit and joiner clip, including glass lites, in an assembled position in accordance with an example embodiment of the present disclosure;

FIG. 18 is a left side elevation view of a spacer frame assembly joiner clip in accordance with another example embodiment of the present disclosure;

FIG. 19 is a top plan view of FIG. 18;

FIG. 20 is a front elevation view of FIG. 18; and

FIG. 21 is a perspective view of an insulating glass unit and joiner clip, including glass lites, in an assembled position in accordance with another example embodiment of the present disclosure.

An appendix is attached and incorporated by reference for all purposes and is part of this application.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures generally wherein like numbered features shown therein refer to like elements having similar characteristics and operational properties throughout unless otherwise noted. The present disclosure relates to a joiner clip for a spacer frame and method of making same, and more specifically, a joiner clip for use in traditional and thermally efficient spacer frames for use with insulating glass units.

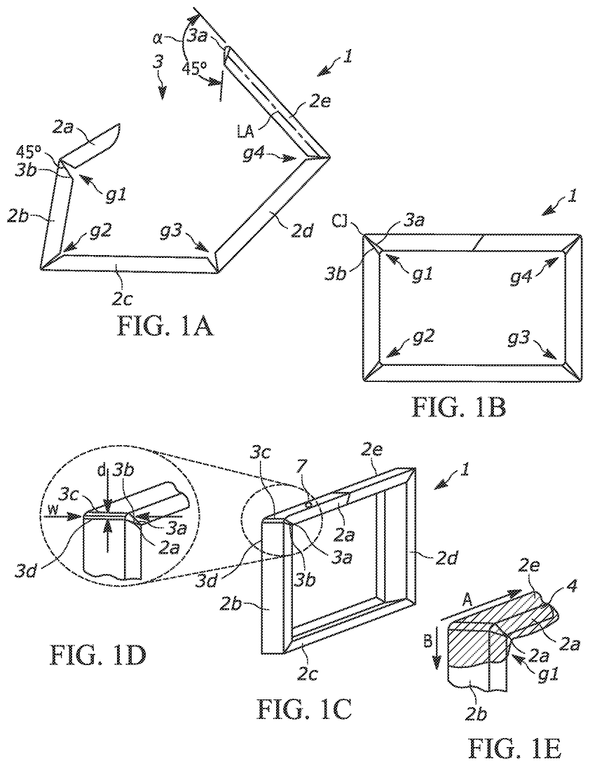

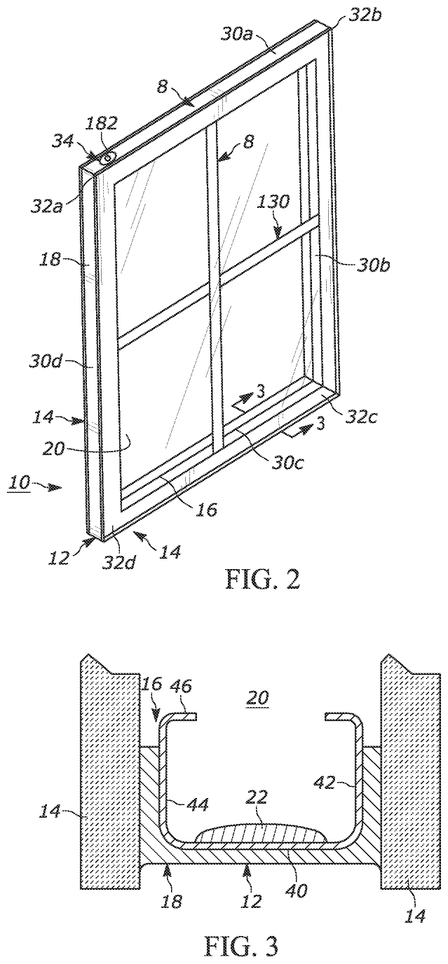

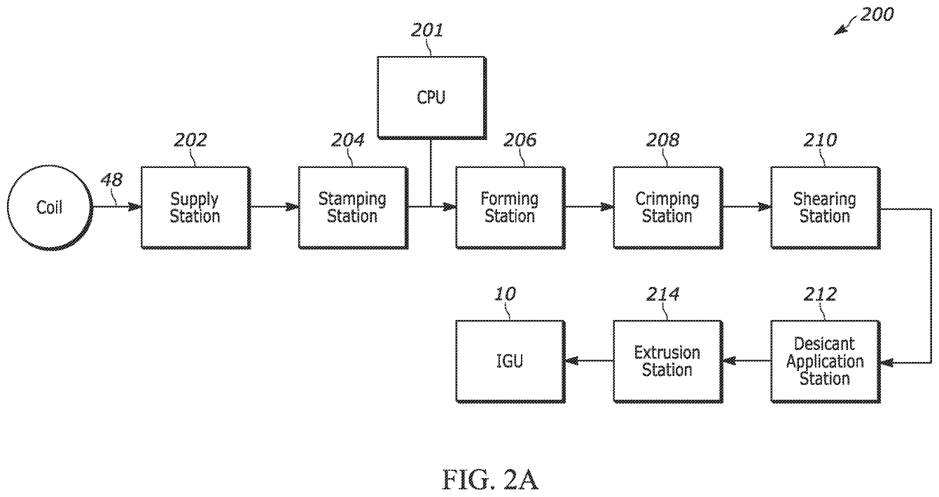

The drawing figures and following specification disclose a method and apparatus for producing elongated window spacer frames 1 and 12 and window components 8 (see FIGS. 1A-1E and 2) used in IGUs 10. Examples of elongated window components include spacer frame assemblies 1, 12 that form parts of the IGUs 10. The IGU components 8 are formed in one example embodiment from a production line, which forms sheet metal ribbon-like stock material into muntin bars and/or spacers carrying sealant and desiccant for completing the construction of IGUs. It should be appreciated that other materials, such as plastics, steel, and polymers, or any combination thereof could be used to make the spacer frame 1 and/or 12 and the components 8. For example, the spacer frame in one example embodiment resembles the thermal spacer frame found in the appendix, owned by the assignee of the present disclosure and incorporated herein by reference in its entirety for all purposes.

Illustrated in FIGS. 1A-1E is first embodiment of a spacer frame 1 fabricated for IGUs. The spacer frame 1 is typically fabricated from an elongated metal strip and roll-formed into the orientation shown. The spacer frame 1 includes five different legs, 2a, 2b, 2c, 2d, and 2e. Leg 2a is a tab that when the spacer frame 1 is assembled is inserted into leg 2e to form a corner juncture or connection at CJ. Legs 2b-2e make up the four sides of the spacer frame 1. When the spacer frame 1 is bent from a linear strip into the four-sided frame (as illustrated by the transition from FIGS. 1A-1B) the leg 2e includes a chamfered end 3, typically as an angle α of 45 degrees from a longitudinal axis “LA” that extends along the center of leg 2e. This allows the tab leg 2a to be completely inserted into leg 2e until end sides 3a and 3c (see FIG. 1D) of the leg 2e bottom out on corresponding ends 3b and 3d to form corner juncture CJ. The insertion of the tab leg 2a into the leg 2e aligns apertures 7 in the tab leg and leg. Further discussion of the fabrication process of the spacer frame is discussed in U.S. Pat. No. 5,361,476 to Leopold, which is incorporated herein by reference in its entirety.

In the assembled position, the spacer frame 1 includes four gaps g1, g2, g3, and g4. The gap g1 is formed by the legs 2a and 2b and the passage the sliding of leg 2e over the leg 2a at end 3 of the corner juncture CJ. FIG. 1e illustrates the passage of hot melt or sealant 4 along directions A and B on the the spacer frame 1 such that the corner juncture CJ is sealed along two directions, over the entire profile of the spacer frame.

Illustrated in FIG. 2A is a schematic block diagram of a production line for manufacturing a spacer frame and insulating glass unit as further described in U.S. Pat. No. 7,610,681, which is incorporated herein by reference in its entirety. The production line 200 may be used to fabricate the insulating glass units 10 and spacer frame assemblies 1, 12 of the present disclosure. A stock strip 48 of material is fed endwise from a coil from a supply station into the production line 200 and substantially completed elongated window components 8 emerge from the other end of the line.

The production line 200 comprises a stock supply station 202, a stamping station 204 where various notches, hole indentations, apertures, projections, or lines of weaknesses, and tab profiles are punched into flat stock 48, a forming station 206 where the flat stock 48 is roll formed to make a u-shaped channel 33, a crimping station 208 where corners are bent and swaging is performed on the tab portion of the u-shaped channel, a shearing 210 station where the individual spacer frames are separated from the flat stock and cut to length and/or apertures and/or projections are stamped, a desiccant application station 212 where desiccant is applied between glass lites and the interior region formed by the lites and spacer frame assembly, and an extrusion station 214 where sealant is applied to the yet to be folded frame.

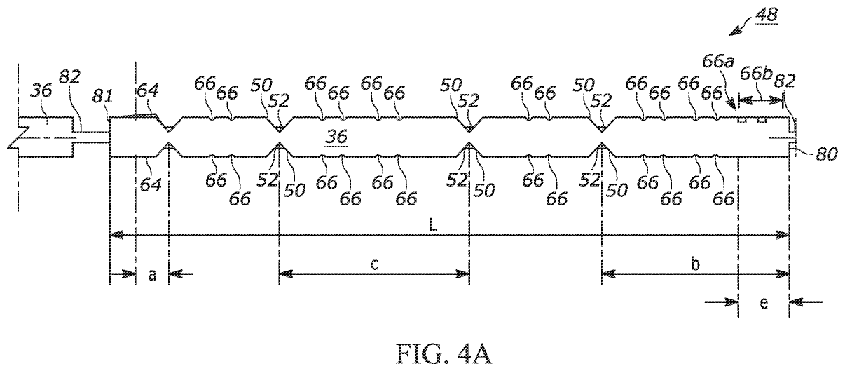

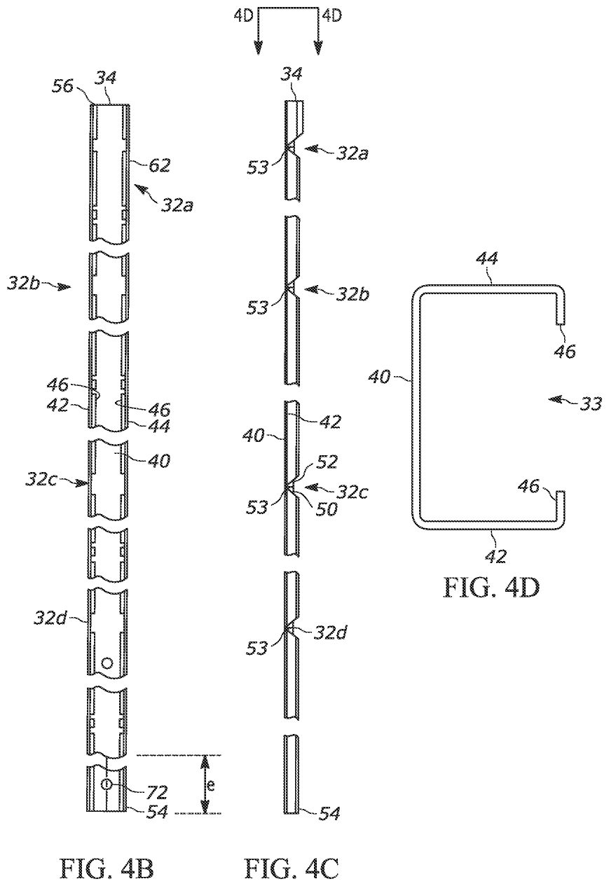

With reference to the operation of the stamping station 204, dies on opposite side of the strip 48 are driven into contact with the metal strip by an air actuated drive cylinder enclosed within the stamping station. In the illustrated embodiment, two air actuated cylinders drive a die support downward, moving spaced apart dies into engagement with the strip 48 to form the punch strip 36 (see FIG. 4A), which is backed by an anvil in the region of contact with the dies.

Due to the need to fabricate spacer frame assemblies 12 of different widths relative to the lateral walls, 42, 44, the dies are movable with respect to each other so that the region of contact between die and strip 48 is controlled. When the width of the spacer frame between the lateral walls 42, 44 changes the relative position of lateral walls, the two dies are also adjusted. In one example embodiment, the separated air cylinder drive forms apertures and/or projections. Coordination of these separate actuations is controlled by movement of the strip 48 through the stamping station 204 to appropriate positions for forming the corners of the spacer frame.

An insulating glass unit 10 illustrated in FIG. 2 is constructed using the method and apparatus further described in FIG. 2A as discussed above and in U.S. Pat. Nos. 8,720,026 and 7,448,246, which are both incorporated herein by reference in their entireties. In FIG. 2, the IGU 10 comprises a spacer frame assembly 12 sandwiched between glass sheets, or lites, 14. The spacer frame assembly 12 comprises a frame structure 16, sealant material 18 for hermetically joining the frame to the lites 14 to form a closed space 20 within the unit 10 and a body 22 of desiccant in the space 20, as illustrated in FIG. 3. The insulating glass unit 10 is illustrated in FIG. 2 as in condition for final assembly into a window or door frame, not illustrated, for ultimate installation in a building. The unit 10 illustrated in FIG. 2 includes muntin bars 130 that provide the appearance of individual window panes. The insulating glass unit with spacer frame 12 can be used with two spacer frames to form triple IGUs, i.e. with three glass lites as further describe in U.S. Pat. No. 9,416,583 that is assigned to the assignee of the present disclosure. U.S. Pat. No. 9,416,583 Patent is incorporated herein by reference.

The assembly 12 maintains the lites 14 spaced apart from each other to produce the hermetic insulating “insulating air space” 20 between them. One of ordinary skill in the art would appreciate that the assembly 1, of FIGS. 1A-1E, or another assembly embodiment 10 could also be used to maintain the lites 14 spaced apart from each other. The frame structure 16 and the sealant body 18 co-act to provide a structure, which maintains the lites 14 properly assembled with the space 20 sealed from atmospheric moisture over long time periods during which the unit 10 is subjected to frequent significant thermal stresses. The desiccant body 22, as illustrated in the example embodiment of FIG. 3, removes water vapor from air, or other volatiles, entrapped in the space 20 during construction of the unit 10.

The sealant body 18 both structurally adheres the lites 14 to the spacer assembly 12 and hermetically closes the space 20 against infiltration of airborne water vapor from the atmosphere surrounding the unit 10. The illustrated body or sealant 18 is formed from a number of different possible materials, including for example, butyl material, hot melt, reactive hot melt, modified polyurethane sealant, and the like, which is attached to the frame sides and outer periphery to form a U-shaped cross section.

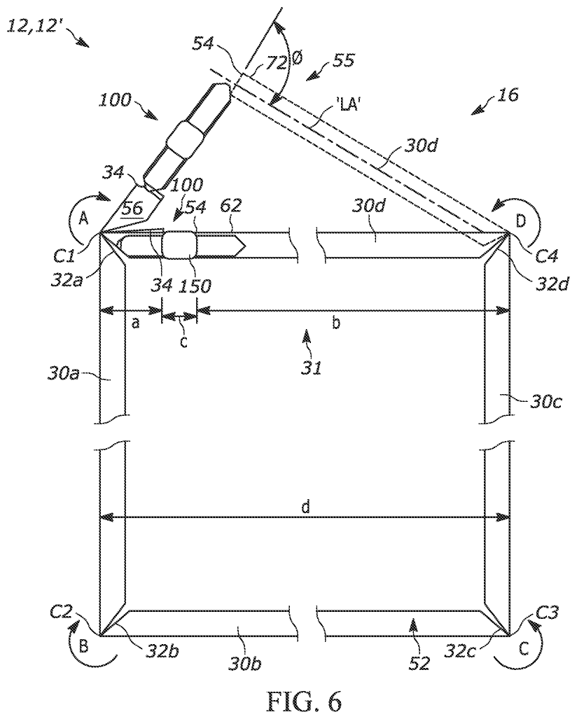

The spacer frame assembly 12 extends about the unit periphery to provide a structurally strong, stable spacer for maintaining the lites 14 aligned and spaced while minimizing heat conduction between the lites via the frame. In one example embodiment, the frame structure 16 comprises a plurality of spacer frame segments, or members, 30a-30d connected to form a planar, polygonal frame shape, element juncture forming frame corner structures 32a-32d, and a front channel end 34 for joining via a joiner clip 100 to an opposite frame end 56 or tail 30d to complete the closed frame shape (see FIG. 6).

Each frame member 30 is elongated and has a channel shaped cross section defining a peripheral wall 40 and first and second lateral walls 42, 44. See FIGS. 2, 3, 4B, 4C, 4D, 5B-5D, and 6. The peripheral wall 40 extends continuously about the unit 10 except where the front channel end 34 joins the frame member end 30d via the joiner clip 100. The lateral walls 42, 44 are integral with respective opposite peripheral or base wall 40 edges. The lateral walls 42, 44 extend inwardly to form a channel 33 with the peripheral wall 40 in a direction parallel to the planes of the lites 14 and the frame structure 16. The illustrated frame structure 16 has stiffening flanges 46 formed along the inwardly projecting lateral wall 42, 44 edges. The lateral walls 42, 44 add rigidity to the frame member 30 so it resists flexure and bending in a direction transverse to its longitudinal extent. The flanges 46 stiffen the lateral walls 42, 44 further so they have an increased resistance to bending and flexure transverse to their longitudinal extents.

In the illustrated example of FIG. 4A, the frame assembly 12 is initially formed as a continuous straight channel 33 constructed from a thin ribbon of metal or flat stock 48. One example of suitable metal includes stainless steel material having a thickness of 0.006-0.010 inches. Other materials, such as galvanized, tin plated steel, or aluminum, plastic, or foam can also be used to construct the channel 33 without departing from the spirit and scope of the present disclosure.

Illustrated in FIG. 4A is the continuous metal ribbon or flat stock 48 after it is passed through a stamping station and punched by a number of dies to form notches 50 and weakening zones 52 for corner folds 32, clip notches 66 (used in securing muntin bars), a front cut 81 and an end cut 80. A punch strip 36 of flat stock forms a single spacer frame assembly 12 as illustrated in repeating sections by dimension “L” from the continuous strip 48. The punch strip 36 is eventually sheared to make a spacer frame assembly 12 at end 80 and the front cut 81, leaving scrap piece 82. Alternatively, the punching or shearing operation is a single hit operation in which the width of the shear equals that of scrap piece 82, leaving no scrap or need for a double hit operation. Further discussion relating to the shearing or punching operation is discussed in U.S. Pat. No. 8,720,026, which is incorporated herein by reference.

Clip notches 66 are formed to support flexible clips that reside within the spacer frame assembly 12 and IGU once assembled. The flexible clips are used to support, for example, muntin bars as further discussed in U.S. Pat. No. 5,678,377, which is incorporated herein by reference. Notches 50 and weakening zones 52 are punched and crimped into the continuous strip 48, allowing for the formation of the corner structures 32. Further discussion of the punching and crimping operations is discussed in U.S. Pat. No. 7,448,246, which is incorporated by reference. In one example embodiment, additional clip notches 66a are formed a first clip distance 66b from the front cut 81 and/or the end cut 82. In one example embodiment, the first clip distance 66b is between 0.250 inches to about 0.265 inches.

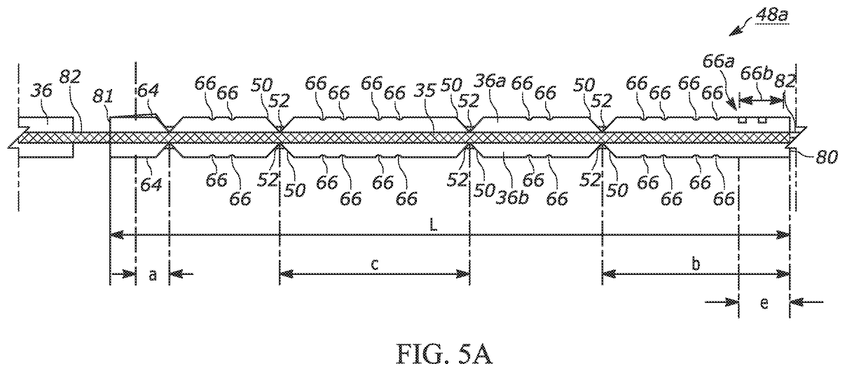

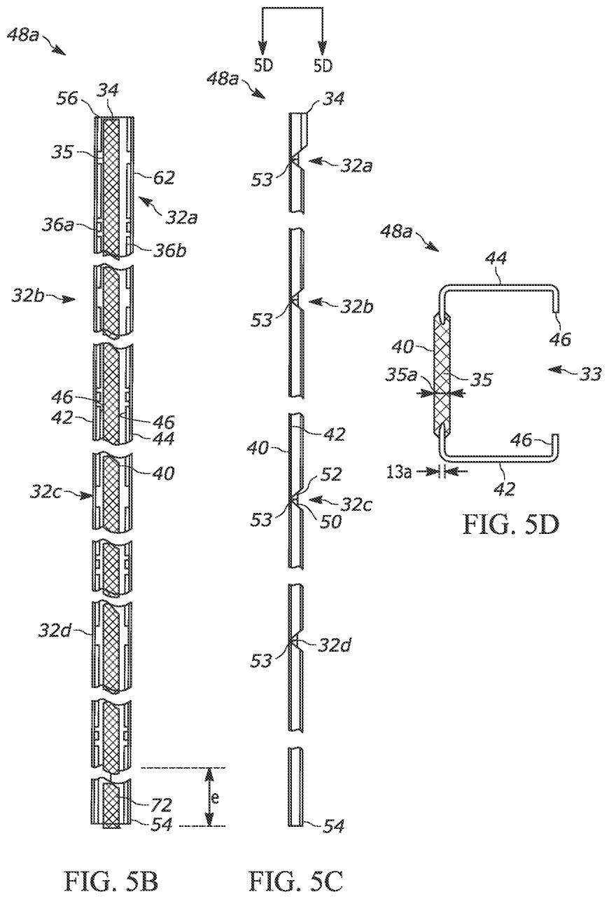

As illustrated in FIGS. 5A-5D, a frame stock 48a of FIG. 5A is substantially the same as the frame stock 48 as discussed in regard to FIG. 4A, except that a thermal interruption strip 35 connects and spaces first and second portions 36a, 36b of the punch strip 36. The thermal interruption strip 35 in one example embodiment comprises a non-thermally conductive material such as a polymer (e.g., aliphatic or semi-aromatic polyamides (Nylon), polyethylene, polyester, epoxy, etc.), a plastic (e.g., polyethylene terephthalate, high-density polyethylene, polyvinyl chloride, etc.) rubber, hardening agents (e.g., calcium carbonate, talc, barium sulphate, glass fibers, etc.), bonding agents (e.g., polyvinyl acetate) or a combination thereof. The thermal interruption strip 35 comprises a durometer between 70-90 Shore D which has a sufficient rigidity at temperatures up to below 100° C., to maintain the shape of the channel, and the lateral walls 42, 44. A film (not shown) overlays at least a portion of the thermal interruption strip 35. In one example embodiment, the film comprises an air tight film such as a metalized polyester film, to prevent loss of thermally efficient insulating fluids (e.g., He, Ne, Ar, Kr, Xe, or the like) from the space 20. In one example embodiment, the film comprises a low moisture vapor transition rate (MVTR) barrier film. Further discussion of a thermal frame stock 48a is found in the appendix which is incorporated herein in its entirety for all purposes.

Before the punch strip 36 is sheared from the continuous strip 48, 48a, it is roll formed to the configuration illustrated in FIGS. 4B-4D and 5B-5D, creating peripheral wall 40, lateral walls 42, 44, and stiffening flanges 46. Further discussion as to the roll forming operation is discussed in U.S. Pat. No. 8,904,611, which is incorporated herein by reference.

The corner structures 32 are formed to facilitate bending the frame channel to the final, polygonal frame configuration in the unit 10 while assuring an effective vapor seal at the frame corners, as seen in FIGS. 2 and 6. The sealant body 18 is applied and adhered to the channel 33 before the corners are bent. The corner structures 32 initially comprise notches 50 and weakened zones 52 formed in the walls 42, 44 at frame corner locations. See FIGS. 3, 4A-4C, 5A-5C. The notches 50 extend into the lateral walls 42, 44 from the respective lateral wall edges. The lateral walls 42, 44 extend continuously along the frame 12 from one end to the other. The lateral walls 42, 44 are weakened at the corner locations because the notches 50 reduce the amount of lateral wall material and eliminate the stiffening flanges 46 and because the lateral walls are stamped to form a line of weakness 53 (see FIGS. 4C, 5C) to weaken them at the corners 32a-32d and thus allow inward flexing as the spacer frame assembly 12 is bent.

As illustrated in FIGS. 5B-5D, wherein the channel 33a is substantially the same as the channel 33 discussed with regard to FIGS. 4B-4D, except that the peripheral wall 40 of the channel comprises the first and second portions 36a, 36b of the punch strip 36 spaced from each other and linked to each other by a thermal interruption strip 35. The peripheral wall 40, including the thermal interruption strip 35 extends continuously about the IGU 10 except where the joiner clip 100 joins the frame member ends 34, 54. A spacer frame assembly 12′ is formed form the strip 48′, and has the thermal interception strip 35 extending around the periphery of the frame.

As illustrated in FIG. 6, the front channel end 34 receives the joiner clip 100, as discussed in greater detail below, as does an opposite frame end 54 or leg member 30d when the spacer frame assembly 12, 12′ has been bent to its final configuration. That is, rotating the linear spacer frame assembly 12, 12′ segments or members 30 (from the linear configuration of FIGS. 4B and 5B) in the direction of arrows A, B, C, and D as illustrated in FIG. 6 and particularly, inserting the joiner clip 100 into connecting the front channel end 34 and into the opposite channel 55 with concomitant rotation of the segments (arrows A-D). This concomitant rotation continues until the joiner clip 100 slides into the front channel end 34 and the opposite channel 55 of segment 30d at the opposite end 54. In the illustrated example embodiment of FIG. 6, the opposite end 54 and the front channel end 34 are coupled together by the joiner clip 100 to make a compound lateral leg 31.

In one example embodiment, the joiner clip 100 forming the lateral leg 31 is spaced from the corner structures 32, which in the illustrated example embodiment of FIG. 6 is C1. When assembled, the joiner clip 100 maintains the frame 12, 12′ in its final polygonal configuration prior to assembly of the insulating glass unit 10. As in the illustrated example embodiment of FIG. 6, the compound lateral leg 31 has a length of dimensions “a” (the front channel end 34 from the corner C1) plus “b” (the fourth frame segment or member 30d) plus “c” (a body portion 150 of the joiner clip 100), which equals the length of dimension “d” (see FIG. 6), the length of a second and opposite side segment 30b.

In the illustrated example embodiments, the joiner clip 100 defines a gas fill aperture 182a. The gas fill aperture 182a provides a temporary vent for the evacuation of air or insertion of gas into the space 20 while the unit 10 is being fabricated. The joiner clip 100 comprise one of a polymer, a plastic, metal, natural rubber, a layered composite of these materials, or a combination thereof. The joiner clip 100 is formed by injection molding, extrusion, press molding, or a combination thereof.

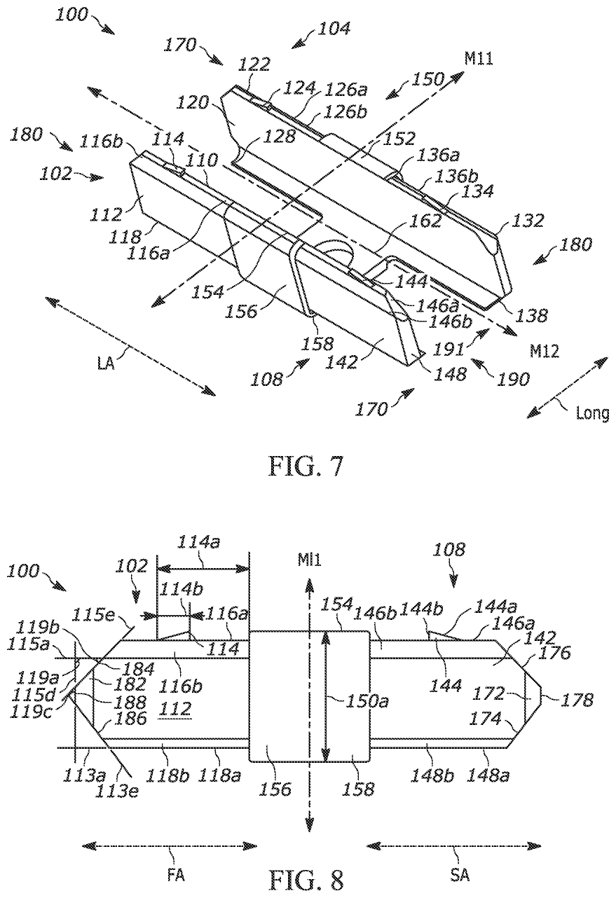

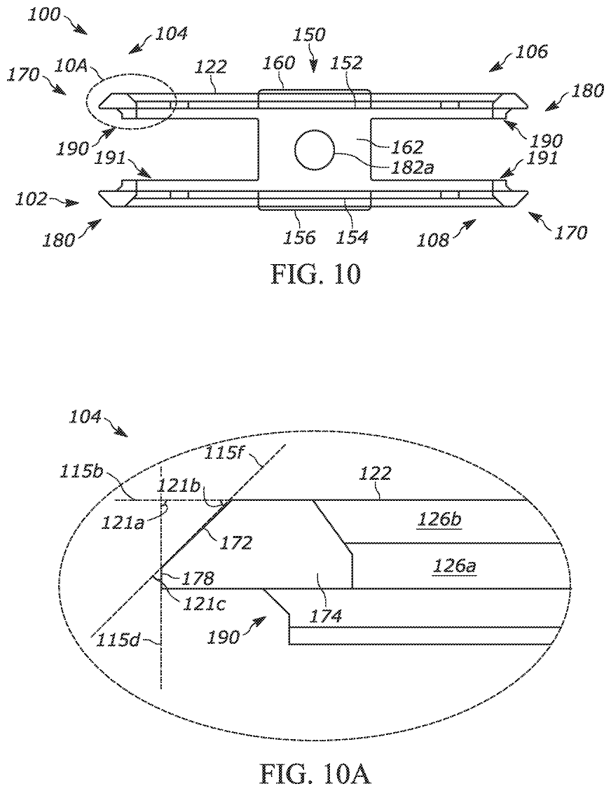

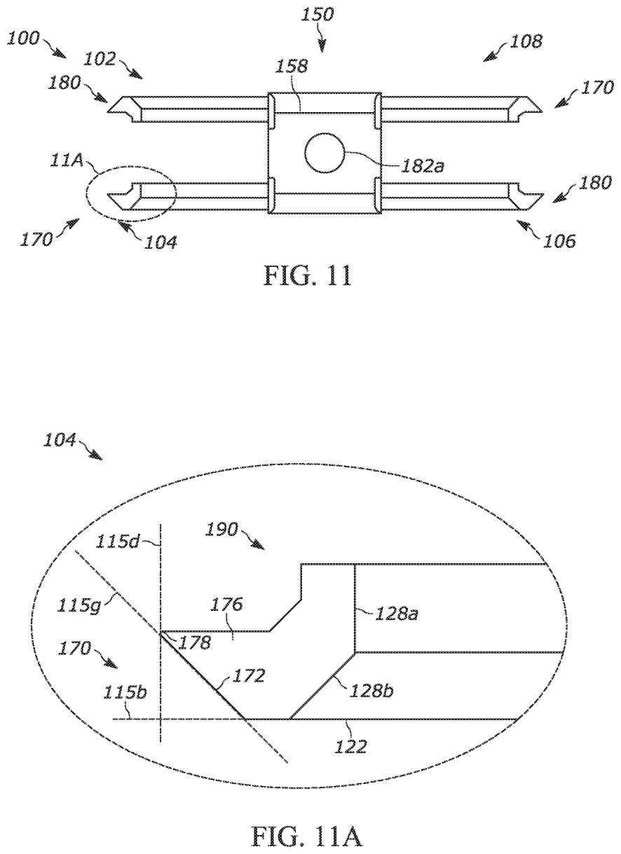

In the illustrated example embodiment of FIGS. 7-11, the body portion 150 defines outer channel lateral walls 156, 160 (see, for example, FIG. 10) coupled together by an outer channel peripheral wall 158. The body portion 150 further defines an inner channel peripheral wall 162 and at least a portion of inner channel walls 110 and 120. The outer channel peripheral wall 158 and the inner channel peripheral wall 162 define the gas fill aperture 182a (see, for example, FIGS. 10-11). Stated another way, the gas fill aperture 182a is a through-hole defined by the outer channel peripheral wall 158 and the inner channel peripheral wall 162.

In the illustrated example embodiment of FIGS. 7-11, the joiner clip 100 has first, second, third and fourth legs 102, 104, 106, 108 that extend from and are coupled to the body portion 150 of the joiner clip 100. In one example embodiment, the first leg 102 and the fourth leg 108 extend away from the body 150 and each other along a first axis FA (see FIG. 8), while the second leg 104 and the third leg 106 extend away from the body 150 and each other along a second axis SA. In one example embodiment, the first and second axes are parallel to a lateral axis LA. In one example embodiment, the first and fourth legs 102, 108 are mirror images of the second and third legs 106, 108, respectively, across a second mirror image axis MI2. In another example embodiment, the first and second legs 102, 104 are mirror images of the third and fourth legs 106, 108, respectively, across a first mirror image axis MI1. Wherein the first mirror image axis MI1 bisects the body portion 150 at a lateral midpoint (e.g., the midpoint as measured along the lateral axis LA) and the second mirror image axis MI2 bisects the body portion 150 at a longitudinal midpoint (e.g., the midpoint as measured along a longitudinal axis LONG).

The first, second, third, and fourth legs 102, 104, 106, 108 each have an exterior face 118, 128, 138, 148 adjacent to first corner faces 116b, 126b, 136b, 146b, wherein the respective first corner faces couple the respective exterior faces to respective flange faces 116a, 126a, 136a, 146a. The first arm 102, the body portion 150, and the fourth arm 108 define a first interior face 110 that extends along the lateral axis LA and is adjacent and coupled to the flange faces 116a, 146a. The first interior face 110 faces a second interior face 120 that is define by the second arm 104, the body portion 150, and the third arm 106. The second interior face 120 is adjacent and coupled to the flange faces 126a, 136a. In one example embodiment, the first and second interior faces 110, 120 are planar surfaces that are opposite the respective exterior faces 118, 128, 138, 148 and the outer channel lateral walls 156, 160. In one example embodiment, the first and second interior faces 110, 120 are smooth or flat surfaces.

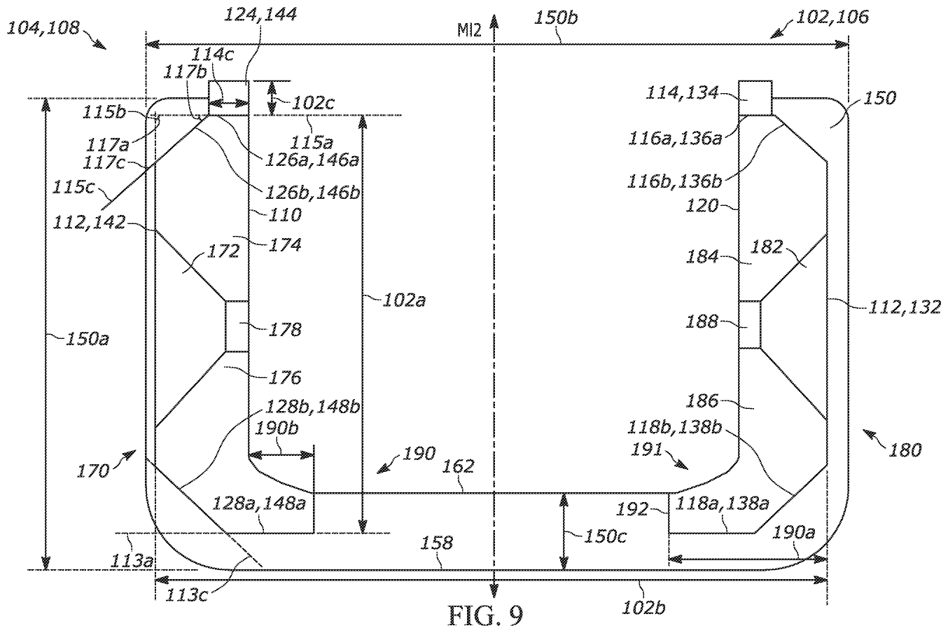

As illustrated in FIGS. 7 and 9, the first arm 102, the body portion 150, and the fourth arm 108 further define a peripheral protrusion 190 that extends along the lateral axis LA and is adjacent and coupled to the interior face 110. A peripheral protrusion 191 is also defined by the second arm 104, the body portion 150, and the third arm 106. The peripheral protrusions 190, 191 are substantially mirror images of each other across the second mirror image axis MI2.

The first, second, third, and fourth legs 102, 104, 106, 108 each have second corner faces 118b, 128b, 138b, 148b adjacent and connected to the respective exterior faces 112, 122, 132, 142. Wherein the respective second corner faces couple the respective exterior faces to respective peripheral faces 118a, 128a, 138a, 148a. The respective peripheral faces 118a, 128a, 138a, 148a couple the interior faces 110, 120 to the peripheral protrusions 190, 191. The first, and third legs 102, 106, have first ends 180. The first ends 180 defining first and second connecting faces 184, 186, a leading face 188, and a directing face 182. The second, and fourth legs 104, 108 have second ends 170. The second ends 170 defining first and second connecting faces 174, 176, a leading face 178, and the directing face 172. In the illustrated example embodiment, the first and second ends 170, 180 are substantially mirror images of each other across the second mirror image axis MI2.

In one example embodiment such as illustrated in FIG. 9, the flange faces 126a, 146a extend along a flange plane 115a, the first corner faces 126b, 146b extend along a first corner plane 115c, and the exterior faces 128, 148 extend along an exterior plane 115b. In one example embodiment, the flange plane 115a extends away from the exterior plane 115b at a first corner angle 117a between 75° to about 105°. In another example embodiment, the corner angle 117a is 90°. In one example embodiment, the flange plane 115a extends away from the corner plane 115c at a slide angle 117b between 25° to about 55°. In another example embodiment, the slide angle 117b is 45°. In one example embodiment, the corner plane 115c extends away from the exterior plane 115b at a lateral angle 117c between 25° to about 55°. In another example embodiment, the lateral angle 117c is 45°. It would be understood that relative dimensions, angles, and defined planes of the flange faces 126a, 146a are substantially the same as the flange faces 116a, 136a except they are mirror images taken across the second mirror image axis MI2. It would be understood that relative dimensions, angles, and defined planes of the corner face 126b, 146b are substantially the same as the corner face 116b, 136b except they are mirror images taken across the second mirror image axis MI2. It would be understood that relative dimensions, angles, and defined planes of the exterior face 128, 148 are substantially the same as the exterior face 118, 138 except they are mirror images taken across the second mirror image axis MI2.

Additionally, as illustrated in FIG. 9, the second corner face 128b, 148b extends along a second corner plane 113c, and the peripheral faces 128a, 148a extend along a peripheral plane 113a. In this example embodiment, the peripheral plane 113a has a same or similar relationship (e.g., angular relationship) with the exterior plane 115b as the flange plane 115a has with the exterior plane. Further, the peripheral plane 113a has a same or similar relationship (e.g., angular relationship) with the second corner plane 113c as the first corner plane 115c has with the flange plane 115a. In the illustrated embodiment, the second corner plane 113c has a same or similar relationship (e.g., angular relationship) with the exterior plane 115b as the first corner plane 115c has with the exterior plane.

It would be understood that relative dimensions, angles, and defined planes of the second corner face 128b, 148b are substantially the same as the second corner face 118b, 138b except they are mirror images taken across the second mirror image axis MI2. It would be understood that relative dimensions, angles, and defined planes of the peripheral face 128a, 148a are substantially the same as the peripheral face 118a, 118a except they are mirror images taken across the second mirror image axis MI2.

In one example embodiment such as illustrated in FIG. 8, a first connecting face 184 extends along a connecting plane 115e, and the leading face 188 extend along the leading plane 115d. In one example embodiment, the leading plane 115d extends away from the flange plane 115a at a second corner angle 119a between 75° to about 105°. In another example embodiment, the second corn angle 119a is 90°. In one example embodiment, the connecting plane 115e extends away from the flange plane 115a at a connecting angle 119b between 25° to about 55°. In another example embodiment, the connecting angle 119b is 45°. In one example embodiment, the leading plane 115d extends away from the connecting plane 115e at a leading angle 119c between 25° to about 55°. In another example embodiment, the leading angle 119c is 45°.

It would be understood that relative dimensions, angles, and defined planes of the first and second connecting faces 184, 186, the leading face 188, and the directing face 182 are substantially the same as first and second connecting faces, the leading face, and the directing face defined by the third arm except they are mirror images taken across the first mirror image axis MIL It would also be understood that relative dimensions, angles, and defined planes of the first and second connecting faces 184, 186, the leading face 188, and the directing face 182 as defined by the first and third arms 102, 106 are substantially the same as first and second connecting faces 174, 176, the leading face 178, and the directing face 172 defined by the second and fourth arms except they are mirror images taken across the second mirror image axis MI2.

Additionally, as illustrated in FIG. 8, the second connecting face 186 extends along a second connecting plane 113e. In this example embodiment, the second connecting plane 113e has a same or similar relationship (e.g., angular relationship) with the front plane 115d as the first connecting plane 115e has with the front plane. Further, the peripheral plane 113a has a same or similar relationship (e.g., angular relationship) with the second connecting plane 113e as the flange plane 115a has with the first connecting plane 115e. In the illustrated embodiment, the peripheral plane 113a has a same or similar relationship (e.g., angular relationship) with the front plane 115d as the flange plane 115a has with the front plane. It would be understood that relative dimensions, angles, and defined planes of the first connecting face 186 is substantially the same as the first connecting face 176 except they are mirror images taken across the second mirror image axis MI2.

In one example embodiment such as illustrated in FIGS. 10, 11, 10A and 11A, the exterior plane 115b extends away from the front plane 115d. In one example embodiment, the exterior plane 115b extends away from the front plane 115d at a front angle 121a between 75° to about 105°. In another example embodiment, the front angle 121a is 90°. In one example embodiment, the directing face 172 extends along a directing plane 115f. In one example embodiment, the directing plane 115f extends away from the exterior plane 115b at a first directing angle 121b between 25° to about 55°. In another example embodiment, the directing angle 121b is 45°. In one example embodiment, the front plane 115d extends away from the directing plane 115f at a second directing angle 119c between 25° to about 55°. In another example embodiment, the second directing angle 119c is 45°.

It would be understood that relative dimensions, angles, and defined planes of the first and second connecting faces 174, 176, the leading face 178, and the directing face 172 are substantially the same as first and second connecting faces, the leading face, and the directing face defined by the fourth arm except they are mirror images taken across the first mirror image axis MIL It would also be understood that relative dimensions, angles, and defined planes of the first and second connecting faces 184, 186, the leading face 188, and the directing face 182 as defined by the first and third arms 102, 106 are substantially the same as first and second connecting faces 174, 176, the leading face 178, and the directing face 172 defined by the second and fourth arms 102, 104 except they are mirror images taken across the second mirror image axis MI2.

Additionally, as illustrated in FIGS. 11-11A, the directing face 172 extends along a second directing plane 115g. In this example embodiment, the exterior plane 115b has a same or similar relationship (e.g., angular relationship) with the directing plane 115g as the first directing plane 115f has with the exterior plane. Further, the front plane 115d has a same or similar relationship (e.g., angular relationship) with the second directing plane 115g as the first directing plane 115f has with the front plane 115d. It would be understood that relative dimensions, angles, and defined plane of the directing face 172 is substantially the same as the directing face 182 except they are mirror images taken across the second mirror image axis MI2.

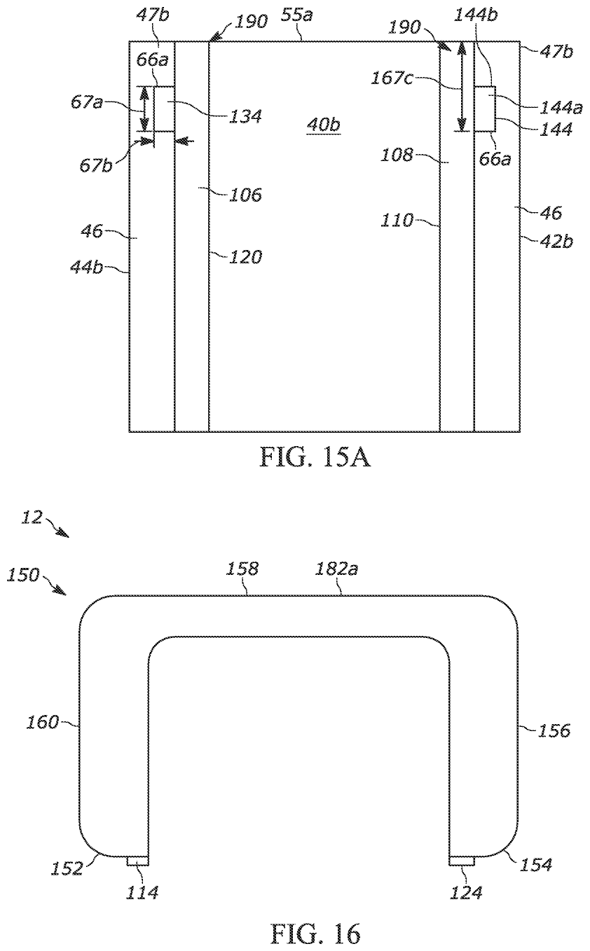

As illustrated in FIG. 9, the arms 102, 104, 106, 108 have an arm height 102a. The arm height 102a is measured from the flange plane 115a to the peripheral plane 113a. In one example embodiment, the arm height 102a is between 7.00 mm to about 7.50 mm. It would be appreciated by one having skill in the art that the arm height 102a may vary from arm to arm. The arms 102, 104, 106, 108 further have an arm thickness 102d (see FIG. 15), wherein the first and second ends 170, 180 are not included in the measurement of the arm thickness. In one example embodiment, arm thickness 102d is between 1.50 mm to about 1.60 mm. Further illustrated in the example embodiment of FIG. 9. The peripheral protrusions 190, 191 have an exterior protrusion width 190a, and an interior protrusion width 190b. In this example embodiment, the exterior protrusion width 190a is measured from the exterior face 112, 122, 132, 142 to a protrusion surface 192.

In another example embodiment, the arms 102, 104, 106, 108 have an arm width 102b. The arm width 102b is measured from exterior plane 115b to exterior plane across the second mirror image axis MI2. In one example embodiment, the arm width 102b is between 11.20 mm to about 11.04 mm. It would be appreciated by one having skill in the art that the arm width 102b may vary from arm to arm. In another example embodiment, the arms 102, 104, 106, 108 support the flange wedge 114, 124, 134, 144. The flange wedge 114, 124, 134, 144 have a wedge height 102c. The wedge height 102c is measured from the flange plane 115a to a most distant from the flange plane point. In one example embodiment, the wedge height 102c is between 0.50 mm to about 0.80 mm. As further illustrated in FIG. 8, the flange wedge 114 starts ascending at an ascending location (e.g., where the wedge begins to extend above the flange face 116a) that is located at a wedge distance 114a from the body 150. Wherein the wedge 114 extends along the flange face 116a for a wedge length 114b. Further, as illustrated in FIG. 9, the wedge 114 has a wedge width 114c that remains constant along the flange face 116a. The dimensions described with regard to the wedge 114 are the same with regard to wedges 124, 134, 144.

As further illustrated in the example embodiment of FIG. 9, the body 150 has a body height 150a and a body width 150b. In one example embodiment, the body height 150a is between 8.00 mm to about 8.20 mm. In another example embodiment, the body width 150b is between 11.80 mm to about 11.90 mm. It would be appreciated by one having skill in the art that the body height 150a and the body width 150b may vary from one side of the body 150 to the other along both the lateral and longitudinal axes LA, LONG. The body height 150a is greater than the arm height 102a, and the body width 150b is greater than the arm width 102b. In one example embodiment, a difference between the arm height 102a and the body height 150a is substantially equal to or greater than a thickness of the stock material 48. In yet another example embodiment, the body 150 has a body thickness 150c. In one example embodiment, the body thickness 150c is between 1.4 mm to about 1.60 mm.

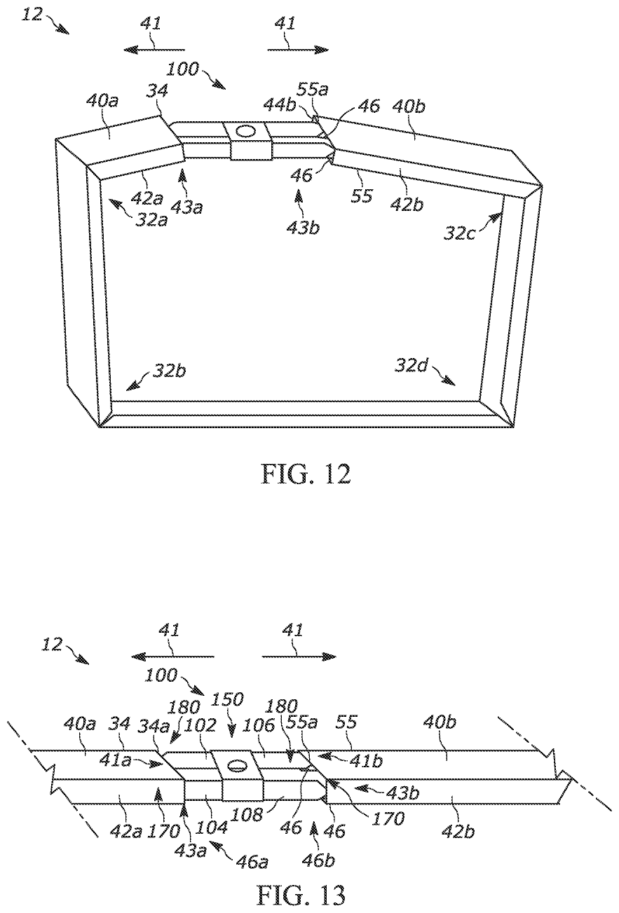

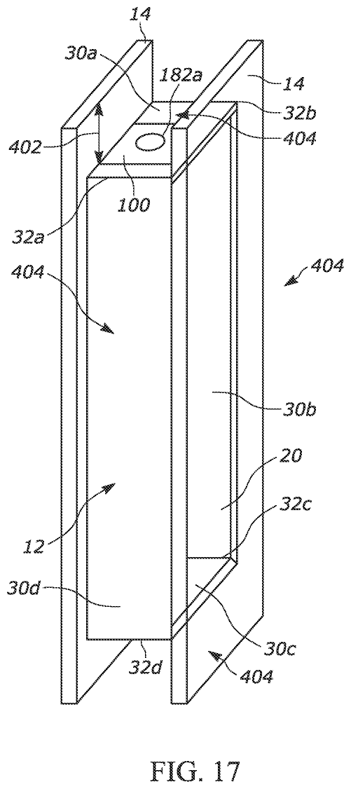

As illustrated in the example embodiments of FIGS. 12-17, the joiner clip 100 is being inserted and/or is housed within the spacer assembly 12 (the thermal interruption strip 35 of the spacer assembly 12′ is omitted for clarity, however, the joiner clip 100 is inserted in the same manner into the spacer assembly 12 as it is into the spacer assembly 12′). As illustrated in FIG. 12, during assembly the joiner clip 100 is inserted 41 into the opposite channel 55 and the front channel end 34. Upon initial insertion, the lateral walls 42a, 42b, the peripheral walls 40a, 40b and the stiffening flanges 46 of the opposite channel 55 and the front channel end 34, respectively, interact with the first and second ends 170, 180 of the joiner clip 100. Planes 115a-115g, 113a, 113c, 113e, and the angles 117a-117c, 119a-119c, and 121a-121c direct the arms 102, 104, 106, 108 into the opposite channel 55 and the front channel end 34. In one example embodiment, first and second lateral edges 43a, 43b defined by the first lateral walls 42a, 42b, as well as edges (not shown) of the second lateral walls 44 of the front channel end 34 and the opposite channel 55, respectively, interact with the directing faces 172, 182 of the first, second, third, and fourth arms 102, 104, 106, 108, respectively. Concurrently, first and second flange edges 46a, 46b defined by the flanges 46 of the front channel end 34 and the opposite channel 55, respectively, interact with the second connecting faces 176, 186 of the first, second, third, and fourth arms 102, 104, 106, 108, respectively. Further, concurrently, first and second peripheral edges 41a, 41b defined by the peripheral wall 40a, 40b of the front channel end 34 and the opposite channel 55, respectively, interact with the first connecting faces 174, 184 of the first, second, third, and fourth arms 102, 104, 106, 108, respectively. In another example embodiment, either first and second arms 102, 104 are inserted in the front channel end 34, or the third and fourth arms 106, 108 are inserted in the front channel end before the non-inserted set of arms is inserted into the channel that has not received arms.

The first and second connecting faces 174, 184, 176, 186, and the directing face 172 facilitate insertion of the joiner clip 100 by guiding the first and second peripheral edges 41a, 41b to interact with the peripheral faces 118a, 128a, 138a, 148a, the first and second lateral edges 43a, 43b to interact with the exterior faces 112, 122, 132, 142, and the first and second flange edges 46a, 46b to interact with the flange faces 116a, 126a, 136a, 146a. As the joiner clip 100 continues insertion into the front channel end 34 and the opposite channel 56, the flange faces 116a, 126a, 136a, 146a interact with the stiffening flanges 46, while the peripheral faces 118a, 128a, 138a, 186a interact with the peripheral walls 40a, 40b, and the exterior faces 112, 122, 132, 142 interact with the lateral walls 42a, 42b, 44 a slidable friction fit is created between the arms 102, 104, 106, 108 of the joiner clip and the spacer frame 12.

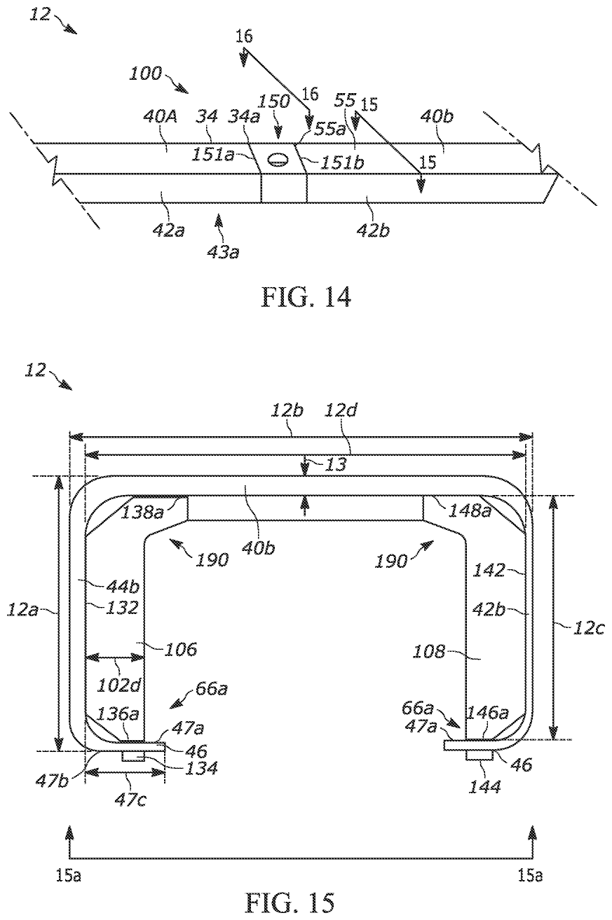

The joiner clip 100 is inserted into the opposite channel 55 and the front channel end 34 until a leading edge 34a of the front channel end 34 makes contact with a first side 151a of the body 150, and a leading edge 55a of the opposite channel 55 makes contact with a second side 150b of the body 150 (see FIG. 14). As illustrated in FIG. 15, a channel height 12a of the spacer frame 12 is substantially the same, or less then the body height 150a (see FIG. 9). In this example embodiment, the channel height 12a is measured from an exterior flange surface 47b to an exterior surface of the peripheral wall 40b. As further illustrated in FIG. 15, a channel width 12b of the spacer frame 12 is substantially the same, or less then the body width 150b (see FIG. 9). In this example embodiment, the channel width 12b is measured from an exterior lateral surface of the first lateral wall 42b to an exterior lateral surface of the second lateral wall 44b. In one example embodiment, the channel width 12b is substantially the same, or greater than the body width 150b (see FIG. 9). In one example embodiment, the channel width 12b is between 1 mm to about 10 mm greater than the body width 150b. In another example embodiment, the channel width 12b is between 1 mm to about 10 mm less than the body width 150b

Additionally, an interior channel height 12c is substantially the same, or greater than the arm height 102a (see FIG. 9). In one example embodiment, the interior channel height 12c is between 1 mm to about 10 mm greater than the arm height 102a. In this example embodiment, the interior channel height 12c is measured from an interior flange surface 47a of the flange 46 to an interior peripheral surface of the peripheral wall 40b. The interior peripheral surface is opposite the exterior peripheral surface. In the illustrated embodiment of FIG. 15, an interior channel width 12d is substantially the same, or greater than the arm width 102b (see FIG. 9). In one example embodiment, the interior channel width 12d is between 1 mm to about 10 mm greater than the arm width 102b. In this example embodiment, the interior channel width 12d is measured from an interior lateral surface of the first lateral wall 42b to an interior lateral surface of the second lateral wall 44b. The interior lateral surface of the first lateral wall 42b is opposite the exterior lateral surface of the first lateral wall, and the interior lateral surface of the second lateral wall 44b is opposite the exterior lateral surface of the second lateral wall.

In the illustrated embodiment of FIG. 15, a spacer thickness 13 is substantially equal to a difference between the arm height 102a and the body height 150a and the arm width 102b and the body width 150b. In one example embodiment, the spacer thickness 13 is constant around the channel (e.g., equal to the stock 48 width). In another example embodiment, the spacer thickness 13 is greater along at least a portion of the peripheral wall 40 than the rest of the channel. In this example embodiment, the thermal interruption strip 35 has a thermal spacer thickness 35a that is greater than the spacer thickness 13a (see FIG. 5D). In this example embodiment, the spacer thickness 13a is substantially equal to the difference between the arm width 102b and the body width 150b and the thermal spacer thickness 35a is substantially equal to the difference between the arm height 102a and the body height 150a.

Stated another way, and as illustrated in the example embodiment of FIG. 15, when the arms 106, 108 are fully inserted into the opposite frame end 55, the peripheral faces 138a, 148a of the third and fourth arms are in contact with the interior peripheral surface of the peripheral wall 40b, the exterior faces 132, 142 are in contact with the interior lateral surfaces of the first and second lateral walls 42b, 44b, and the flanges faces 136a, 146a are in contact with the interior flange surface 47a. In this illustrated example embodiment, the flanges 46 have a flange width 47c. The flange width 47c is measured from the interior lateral face of the lateral face 42, 44 coupled to the flange 46, and an edge of the flange. In this example embodiment, the flange width 47c is equal to or greater than the arm thickness 102d. In one example embodiment, the flange width 47c is between 1.80 mm and 2.00 mm. In another example embodiment, a difference between the flange width 47c and the arm thickness 102d is between 0.20 mm and 0.50 mm.

As illustrate in the example embodiment of FIGS. 15 and 15A, the flange wedges 114, 124, 134, 144 reside within one or more additional clip notches 66a. In one example embodiment, the additional clip notches 66a comprise a rectangular shape defined within the flange 46. In this example embodiment, the additional clip notches 66a have a clip length 67a and a first clip width 67b. In one example embodiment the clip length 67a is between 2.90 mm and 3.10 mm and the first clip width 67b is between 0.90 mm and 1.10 mm.

In one example embodiment, such as illustrated in FIG. 15A, the additional clip notches 66a are spaced from the leading edge 55a a clip distance 167c. Wherein the clip distance 167c is measured from a first side of the additional clip notch 66a, wherein the first side is farther from the leading edge 55a than a second side, wherein the second side is opposite the first side along the flange 46. In one example embodiment, the clip distance 167c is between 10.80 mm and 11.20 mm. In another example embodiment, the clip distance 167c is equal to or greater than the wedge distance 114a (see FIG. 8). In another example embodiment a difference between the clip distance 167c and the wedge distance 114a is between 0.50 mm and 1.0 mm. In one example embodiment, the clip length 67a is equal to or greater than the wedge length 114b (see FIG. 8). In another example embodiment a difference between the clip length 67a and the wedge length 114b is between 0.50 mm and 1.0 mm. In one example embodiment, the clip width 67b is equal to or greater than the wedge width 114c (see FIG. 9). In another example embodiment a difference between the clip width 67b and the wedge width 114c is between 0.50 mm and 1.0 mm. In this example embodiment, the wedges 114, 124, 136. 146 interact with the additional clip notches 66a. For example, as illustrated in FIGS. 8 and 15A, an ascending face 144a interacts with the additional clip notch 66a until a front face 144b of the wedge 144 is pushed up and into contact with the additional clip notch by the interaction of the peripheral face 148a with the peripheral wall 40b of the spacer frame 12. It would be appreciated that the other wedges 114, 124, 134 define front faces and ascending faces that interact with the additional clip notches in a same or similar manner as described with regard the wedge 144. That is, the wedge 114, 124, 134, 144 act as ramps, until filling in the notch 66 to lock the clip 100 to the spacer 12.

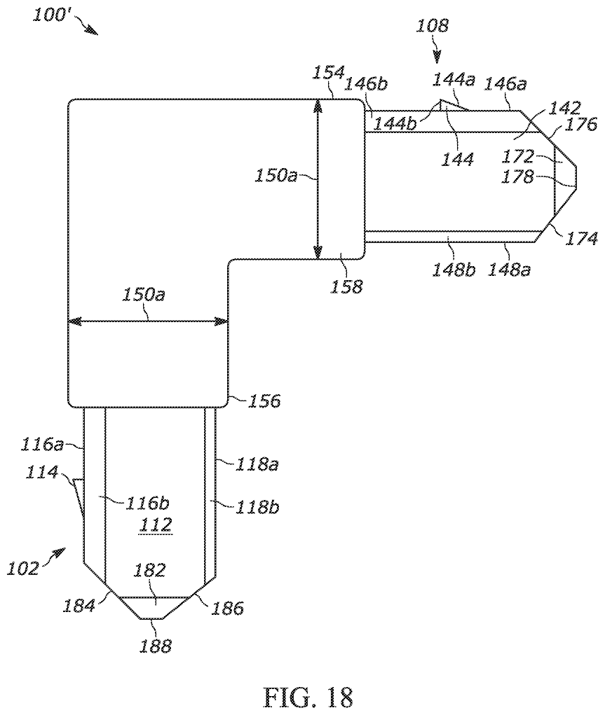

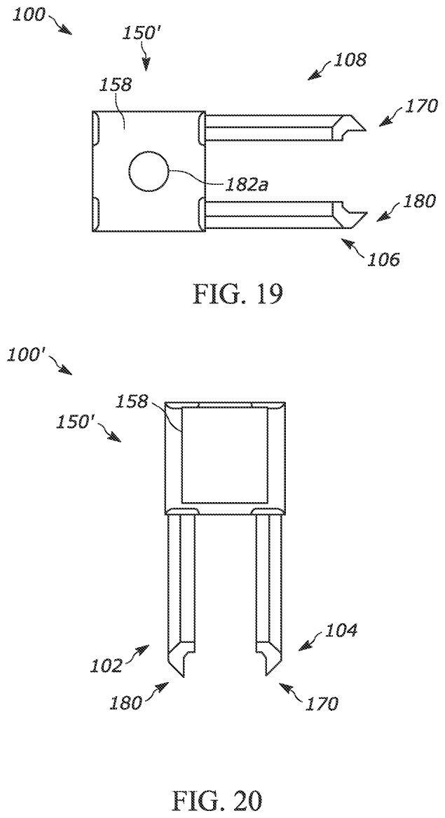

Illustrated in FIGS. 18-21, is a second embodiment of a joiner clip 100′. In this example embodiment, the arms 102, 104, 106, 108 are substantially the same as with the joiner clip 100 illustrated in FIGS. 7-17, however the body 150′ is includes a bend, whereas the body 150 is linear. The body 150′ defines the aperture 182a on a first side of the bend, and a wall on a second side of the bend. The wall acts as a portion of the peripheral wall 40 when assembled. The stock strip 48, 48a that is utilized with the joiner clip 100′ is substantially the same as described with regard to FIGS. 4A, 5A, except that the stock strip has three corner punches 52. Stated another way, after the stock strip 48, 48a is roll formed, the portion of the stock strip that extends out from the first corner 32a is removed. Stated yet another way, the joiner 100′ is inserted into a channel defined by leg 30a, as illustrated in FIG. 6, while being inserted into the opposite frame end 55. In the illustrated embodiments of FIGS. 18-21, the body 150′ has a bend that is about 90°. In other configurations, the bend may be between 45° to about 105°.

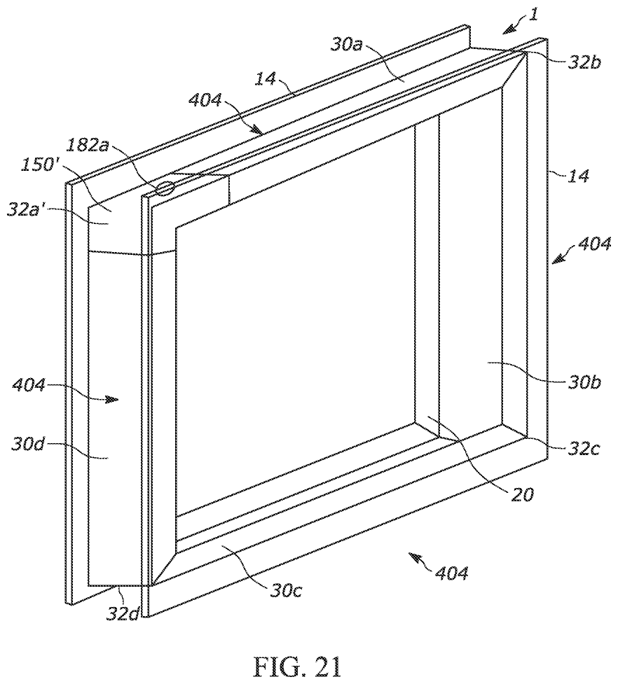

Once the joiner clip 100, 100′ is housed within the front channel end 34 and the opposite frame end 56, lites 14 are coupled to opposing sides of the assembly 12, 12′, as illustrated in FIGS. 17 and 21. Typically, sealant 404 is applied around the sides 30a-30d and over the corners 32a-32d or 32a′, 32b-32d (wherein 32a′ is a corner comprised by the joiner clip 100′) to form the insulating air space 20 between the lites 14 and the assembly 12, 12′. The sealant is not applied over the aperture 182a. The gas fill aperture 182a is used to evacuate and/or add specific fluids, for example, removing atmospheric air (oxygen, nitrogen, etc.) and adding other fluids, such as inert gases like argon. Traditionally, once the insulating air space 20 has a desired composition, a screw or rivet is placed into the aperture 182a to seal the air inside. Sealant 404 is then applied over the screw or rivet. The sealant 404 is typically applied up to a plane 14a that is even with or below a top plane on which the edges of the lites 14 reside. If the rivet or screw is not inserted correctly, the rivet or screw will exceed a height 402 of the lite 14 above the assembly 12, 12′, causing window failure. Having a single aperture 182a reduces the instance of incorrectly inserting the rivet or screw. Further, a head of the rivet or screw adds additional surface areas that add additional point of sealant 404 unevenness and/or thin spots. The aperture 182a reduces failure as it is not deformable, and thus retains is round shape, allowing for easy screw, rivet, or plug insertion.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A joiner clip for coupling two ends of a spacer frame, the joiner clip comprising:
a body extending along a lateral axis and a longitudinal axis;
a first arm coupled to and extending from the body in a first direction parallel to said lateral axis away from the longitudinal axis, and
a second arm coupled to and extending from the body in a second direction opposite the first direction and parallel to the lateral axis away from the longitudinal axis.

2. The joiner clip of claim 2 further comprising:
a third arm coupled to and extending away from the body in the first direction, the third arm comprising a mirror image of the first arm across the lateral axis; and
a fourth arm coupled to and extending away from the body in the second direction, the fourth arm comprising a mirror image of the second arm across the lateral axis.

3. The joiner clip of claim 3, wherein:
the first arm comprises a mirror image of the second arm across the longitudinal axis; and
the third arm comprises a mirror image of the fourth arm across the longitudinal axis.

4. The joiner clip of claim 2, wherein the body comprises a though hole that comprises a gas fill aperture, the gas fill aperture extending through outer and inner channel walls of the body.

5. The joiner clip of claim 1, wherein a first connecting face borders a first corner face, the first corner face extending between the first connecting face and the body.

6. The joiner clip of claim 2, wherein the first and third arms and the body support a first peripheral protrusion, and the second and fourth arms and the body support a second peripheral protrusion, the first and second peripheral protrusions extending along the lateral axis.

7. The joiner clip of claim 1, wherein the body comprises first and second lateral walls, and a peripheral wall, the peripheral coupling the first lateral wall to the second lateral wall.

8. The joiner clip of claim 7, wherein a gas fill aperture is defined within the peripheral wall, the gas fill aperture centrally located between the first and second lateral walls.

9. A method of assembly for a spacer frame assembly comprising the steps of:
providing a spacer frame having a substantially linear channel comprising two lateral walls connected by a peripheral wall, the spacer frame, when assembled, including at least three sides and corresponding corners between each of said sides, the spacer frame defining a primary channel between a first corner and a leading end of the spacer frame and an opposite channel between a second corner and a trailing end of the spacer frame;
providing a joiner clip comprising a body coupled to first and second arms at first ends of the first and second arms, the first and second arms extending away from the body along a lateral axis, the first arm extending in a first direction, and the second arm extending in a second direction, the first direction opposite the second direction, the first and second arms each defining a peripheral face, a lateral face and a flange face, the lateral face linking the peripheral face to the flange face, the first and second arms defining first and second connecting faces coupled to and spaced from each other by a directing face at second ends of the first and second arms, the first ends opposite the second ends, the first connecting face extending transversely from the flange face and the lateral face, the second connecting face extending transversely from the lateral face and the peripheral face, the directing face extending transversely from the lateral face, the first and second connecting faces and the directing face converging at a leading face;
inserting the first arm into the primary channel until the leading end is in contact with the body, the leading end interacting with at least one of the first connecting face, the second connecting face, or the directing face of the first arm during insertion; and
inserting the second arm into the opposite channel until the trailing end is in contact with the body, the trailing end interacting with at least one of the first connecting face, the second connecting face, or the directing face of the second arm during insertion, wherein responsive to the leading and trailing ends being in contact with the body, the spacer frame is in an assembled position.

10. The method of assembly of claim 9, comprising slidably contacting first connecting faces of the first and second arms with stiffening flanges coupled to and supported by the first and second lateral walls of the primary channel and the opposite channel, respectively, during insertion of the first and second arms.

11. The method of assembly of claim 9, comprising slidably contacting the lateral faces of the first and second arms with the lateral walls of the spacer frame during insertion and maintaining contact in the assembled position.

12. The method of assembly of claim 9, wherein inserting the first arm into the primary channel further comprises inserting a third arm of the joiner clip into the primary channel, the third arm extending in the first direction and comprising a mirror image of the first arm across the lateral axis.

13. The method of assembly of claim 12 wherein inserting the second arm into the opposite channel further comprises inserting a fourth arm of the joiner clip into the opposite channel, the fourth arm extending in the second direction and comprising a mirror image of the second arm across the lateral axis.

14. The method of assembly of claim 9, comprising slidably contacting the peripheral faces of the first and second arms with the peripheral walls of the spacer frame during insertion and maintaining contact once the leading and trailing ends are in contact with the body, further wherein spacing corner faces of the first and second arms from the peripheral and lateral walls of the spacer frame, the first corner faces extending between the peripheral faces and the lateral faces of the first and second arms, respectively.

15. The method of assembly of claim 9, wherein inserting the first arm into the primary channel comprises inserting a first flange wedge, supported on the flange face of the first arm, into a clip notch defined in the flange of the primary channel.

16. The method of assembly of claim 15, wherein inserting the second arm into the opposite channel comprises inserting a second flange wedge, supported on the flange face of the second arm, into a clip notch defined in the flange of the opposite channel to secure the spacer frame into the assembled position.

17. The method of assembly of claim 9, comprising maintaining space between the first connecting faces of the first and second arms and the stiffening flanges when the spacer frame is in the assembled position.

18. A spacer frame assembly, comprising:
a spacer frame comprising a substantially linear channel, the channel comprising:
first and second lateral walls connected by a peripheral wall;
at least three sides and corresponding corners between each of the sides when the spacer frame is in an assembled position;
a first leg extending between a first corner and a leading edge of the channel and a second leg extending between a second corner and a trailing edge of the channel; and
first and second stiffening flanges supported by the first and second lateral walls, respectively, the first and second stiffening flanges defining first and second internal faces, the internal faces opposite the peripheral wall of the channel, the spacer frame having a spacer height extending from the stiffening flanges to the peripheral wall, and a spacer width extending between the first and second lateral walls;
a joiner clip for coupling the leading end of the spacer frame to the trailing end of the spacer frame in the assembled position, the joiner clip comprising:
a body comprising a u-shaped channel having first and second channel lateral walls coupled together by a channel peripheral wall, the body having a body height and a body width, the body height substantially equal to the spacer height, and the body width substantially equal to the spacer width, the body extending along a lateral axis and longitudinal axis;
a first arm and a third arm coupled to the body at first ends of the first and third arms, the first and third arms extending away from the body in a first direction parallel to the lateral axis away from the longitudinal axis, a second arm and a fourth arm coupled to the body at first ends of the second and fourth arms, the second and fourth arms extending away from the body in a second direction opposite the first direction and parallel to the lateral axis away from the longitudinal axis, wherein the first and second arms each define a peripheral face, a lateral face and a flange face, the lateral face linking the peripheral face to the flange face, the flange face supporting flange wedges, the first and second arms defining first and second connecting faces coupled to and spaced from each other by a directing face at second ends of the first and second arms, the first ends opposite the second ends, the first connecting face extending transversely from the flange face and the lateral face, the second connecting face extending transversely from the lateral face and the peripheral face, the directing face extending transversely from the lateral face, the first and second connecting faces and the directing face converging at a leading face, the first arm and second arms having an arm height extending between the flange face to the lateral face, the first arm comprising a mirror image of the third arm across the lateral axis, and the second arm comprising a mirror image of the fourth arm across the lateral axis, the first arm spaced from the third arm an arm width, the arm height less than the body height and the arm width less than the body width;
a gas aperture extending through the channel peripheral wall;
responsive to the spacer frame being coupled to the joiner clip in an assembled position:
the leading edge and the trailing edge are in contact with the body;
the first and third arms are housed within the first leg, and the second and fourth arms are housed within the second leg;
the lateral faces of the first and third arms are in contact with the lateral walls of the first leg, and the lateral faces of the second and fourth arms are in contact with the lateral walls of the second leg;
the flange faces of the first and third arms are in contract with the first and second internal faces of the stiffening flange on the first leg, and the flange faces of the second and fourth arms are in contact with the first and second internal faces of the stiffening flanges on the second leg;
the peripheral faces of the first and third arms are in contact with the peripheral wall of the first leg, and the peripheral faces of the second and fourth arms are in contact with the peripheral wall of the second leg;
the flange wedge is housed within a clip notch defined in the stiffening flanges of the first and second legs; and
the first and second connecting faces and the directing face of the arms are spaced from the stiffening flanges, the first and second lateral walls, and the peripheral wall of the first and second legs.

19. The spacer frame assembly of claim 18, wherein the lateral faces are coupled to the peripheral faces by respective first corner faces, and the flange faces are coupled to the lateral faces by respective second corner faces, the first and second corner faces are spaced from the stiffening flanges, first and second lateral walls, and the peripheral wall of the first and second legs when the spacer frame is in the assembled position.

20. The spacer frame assembly of claim 18, wherein a height difference between the body height and the arm height and a width difference between the body width and the arm width is substantially equal to a thickness of the spacer frame.
